(19) United States
(12) Patent Application Publication
(10) Pub. No.: US 2006/0285685 A1
(43) Pub. Date: Dec. 21, 2006

(54) DNA Based Identification and Tracking System

(75) Inventor: Temba James Msezane, Washington, DC (US)

Correspondence Address: PHILIP H. BURRUS, IV, 460 Grant Street, Atlanta, GA, 30312, US

(73) Assignee: Temba James Msezane, Washington, DC (US)

(21) Appl. No.: 11/160,322

(22) Filed: Jun. 19, 2005

(51) Int. Cl. G06F 19/00; G06F 21/22

(52) U.S. Cl. 380/59; 702/20

(57) ABSTRACT

A method and apparatus for tracking and identification of humans and animals via an embedded network consisting of existing communications infrastructure by routing unique DNA profile data packets emitted by a DNA RF MEMS Device. The apparatus consists of a RF enabled transmitter which emits a unique data packet containing DNA information from the subject. The system uses available wireless networks, internet protocols, and databases to be able to locate the subject and allows the subject to project presence or identity instantly, accurately, and securely across any distance. The method and apparatus enable a unique identifier that allows for the “real time” physical, spatial, electronic, and biometric verification of location and identity.

A method and apparatus for the tracking and identity verification of human and animal populations via a distributed network system is described below. The schema revolves around a de-centralized identification service that routes emitted data packets to locate and verify the identity of individuals in a population. The service uses the natural universal identifier (e.g. DNA), for both human and animal populations to route identity specific information through the various networks and databases.

The service consists of an embedded network consisting of existing communications infrastructure and works by routing unique data packets emitted by a DNA RF MEMS (Micro Electrical Mechanical Systems) Device via traditionally Internet Packet Protocols. The apparatus consists of a RF enabled device that emits a unique data packet containing unique DNA information from the subject. The system uses available wireless networks, internet protocols, and software to be able to locate the subject. The method and apparatus enable a unique identifier that allows for the “real time” physical, spatial, electronic, and biometric verification of location and identity.

The service leverages the power of the network and neural net programs to create a autonomous real time location distribution system using the unique identifier that can be only created by the individual's DNA. As the invention relies heavily on existing communications and information networks, as well as existing and future applications (software) and the emitting device, the full concept and scope of the invention cannot be fully documented. The basic categories of the system are 1) the Sensor or Device, 2) the Embedding System and 3) the Process. The Sensor element consists of 1a) a multifunction integrated NEMS/MEMS (Nano/Micro Electrical Mechanical Systems) sensor chip 1b) Probe/Identifier and 1c) RF OLE_LINK1(Radio Frequency)OLE_LINK1 MEMS (Micro Electrical Mechanical Systems) Transceiver. The Embedding System element consists of the 2a) Sensor Platform 2b) Networking and the 2c) Wireless Link. The final element is the Process element which consists of the following components: 3a) Delivery, 3b) Operations 3c) Emission.

The Sensor element describes the real time DNA RF MEMS Device which uses integrated circuits combining RF and sensor functions on the same chip, approaching system-on-a-chip (SoC) implementations. The Probe/Identifier module describes the components for real time DNA identification and capturing the Single Nucleotide Polymorphism (SNP) or Short Tandem Repeats (STR) sequence data. The final component of the Sensor Device is the RF MEMS transceiver. While all of the components of the sensor are currently available in various sizes and forms, this device will combine the three components to create a process that allows for unique location tracking and identity verification.

The Embedding System is a wireless autonomous platform for the DNA sensors which routes the emitted data packet in the network. While the methodology discussed in the description of the identification and location service is based on the specified real time DNA identification sensor coupled with the RF transceiver (i.e. sensor platform or device), the embedding system is functional with RF transmission of unique DNA identifier data packets not obtained through the afore mentioned sensor. The embedding system's sensor platform describes the sensor in terms of functional components allowing for the evolution of the devices to become more sophisticated as the technology evolves and allows for plug and play capabilities based on available components. The Networking element describes the autonomous wireless network of sensor data. The Networking element relies heavily on the standards created for sensor transmission and Internet Protocols based on DNA packets containing the SNP or STR information, Device ID, time, and other accompanying parameters. The data packets are small, fixed, and transmitted in regular pluses via the IEEE 802.15, 802.11, and 1415 standards. This enables the Wireless Link component to utilize a standard, RF MEMS transceiver broadcasting the data packets in real time or close to real time fashion using very little energy.

The Delivery component of the Process element is the unique methodology flow that allows for the DNA RF MEMS Device to be activated by the subject human or animal. Through the specified delivery methods, the device is able to provide a secure and unique identification emission from which location can be tracked, and information can be attached to creating a ubiquitous information wallet, certificate, or file. The Operations component refers to the functions that the sensor platform conducts to obtain and verify the DNA profile. The final Process component is the Emissions which refers to the data packet that is broadcast from the device and includes the physical emissions of the device during the final stage of the process.

### BRIEF DESCRIPTION OF DRAWINGS

FIG. 1 provides the overview conceptualization of the integrated elements and components. The sensor platform across the bottom provides the basis for the integrated device consisting of the physical components listed as block objects. The embedding system network is represented above the device components receiving inputs form the components along the Process steps. The Process is divided into four steps as opposed to the three steps mentioned in the Summary section to highlight the “eject” portion of the emission process representing the mechanical process as opposed to the broadcast portion.

FIG. 2 provides a schematic illustration not drawn to scale of the DNA RF MEMS Device of the present invention. Shown in FIG. 2 are: 1) the DNA probe 2) DNA Chip 3) Timer/Clock 4) RF MEMS Transceiver 5) Battery with optional rechargeable power supply 6) Location device 7) Optional Magnetic Induction component.

FIG. 3 provides a general overview of an autonomous wireless communications network using an Embedded Sensor Network and an IP based DNA Data Packet routing bus.

FIG. 4 is a diagram of the specific Network, Hardware, and Device layers of the DNA Data Layers.

FIG. 5 is a flowchart of the key processes.

### DETAILED DESCRIPTION

As discussed above, the DNA tracking system is based on a device that broadcasts a DNA data packet to a sensor network. The device and the network work in tandem to provide location and identify verification. While many configurations of the device and the network exist of which the elements can be found in the claims section, this description refers to the configuration envisioned by the inventor at the time of filing.

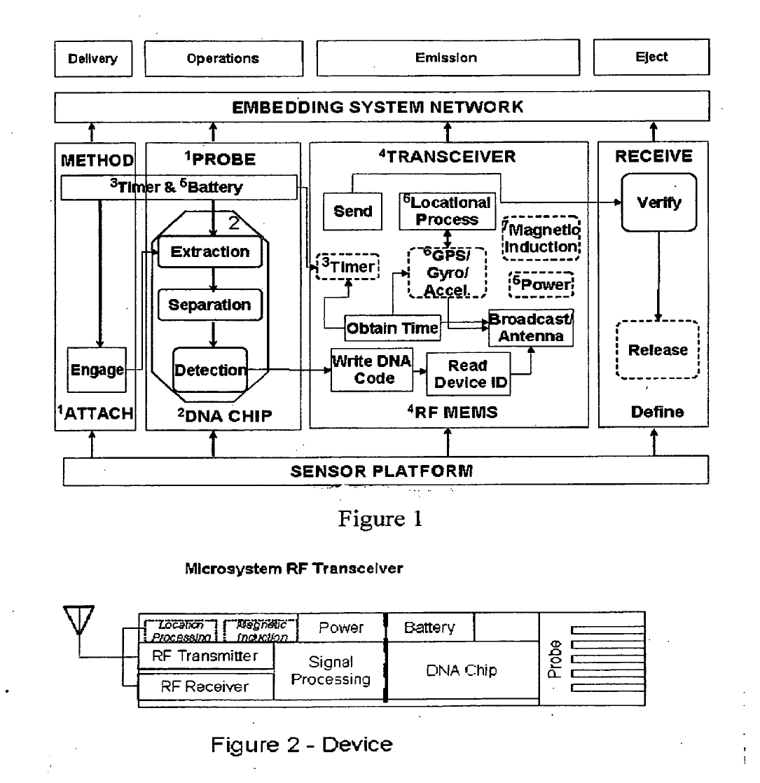

The device, also referred to as the sensor platform, is an apparatus for the broadcasting of the DNA profile. The DNA profile that is included in the data broadcast is one of the following widely accept methods of DNA identification typically using OLE-LINK2Short Tandem Repeats (STRs)OLE_LINK2 or Single Nucleotide Polymorphism (SNP). FIG. 1.1 refers to the integrated attachment (adhesion) of the device via a probe used for DNA extraction. FIG. 1.2 refers to the traditional three step DNA profiling process for obtaining SNP and/or STP information. This process is based on a single use method of extraction of the DNA from the subject, separation of the DNA elements, and detection of the sequences.

There are many methods of DNA typing of which DNA chips are being developed for integrating into MEMS. The device is method independent although certain parameters have to be met. Some of the methods include: SNP-based assays, SNP-haplotyping technology, DNA Sequencing with Nanopores or Nanowires, DNA Analysis using Microcantilever array, labeling free DNA detection using an electrochemical process, labeling free DNA detection using acoustic surface waves. The device is referred to as sensor platform due to the fact that one type of DNA profiling method is not required. Additionally, in the initial build up of the network, traditional RFID tags with the DNA profile embedded within will be used.

FIG. 1.3 refers to the timer or clock component of the platform allowing for internal operations, timed events from delivery to operations and broadcasts of the DNA packets. FIG. 1.4 refers to the transceiver module for communications to the sensor network. FIG. 1.5 refers to the power functions on the sensor platform represented as a battery function for the delivery and DNA chip process and a power function for the emissions functions. These functions are separated in order to allow for technologies that use transmitted power generation, vibration power generation, or chemical reaction power generation to be used for the broadcast functions.

FIG. 1.6 refers to the locational processes associated with determining the location of the device. As with other components of the sensor platform, more than one method a determining location can be used and standard components exist for these functions. As stated in the claims section, the sensor platform may contain a method for determination of location using any combination of GPS, assisted GPS, gyro, accelerometer, high frequency sound (ultrasound), or magnetic induction.

The major functions of the device are delivery of the device to the subject, writing the DNA profile to the device, verification of the DNA profile with the network, broadcasting the DNA data packet on a continuous basis until the device receives instructions to stop operations and release of the probe/attachment mechanism.

As seen in FIG. 2, the components of the device or sensor platform, fit into one integrated system that is divided into two components. The left side of the dotted line, contains the emission or broadcast functions while the right side contains the functions necessary for determination of the DNA profile. The orientation of the components as shown are for illustrative purposes and size is not to scale. The optional magnetic induction component can be replaced with high frequency sound (ultrasound) or optical sensor. The location processing component is a combination of GPS, assisted GPS, gyro, or accelerometer sensor(s) that may be used in conjunction with the optional magnetic induction, high frequency sound (ultrasound), or optical sensor(s).

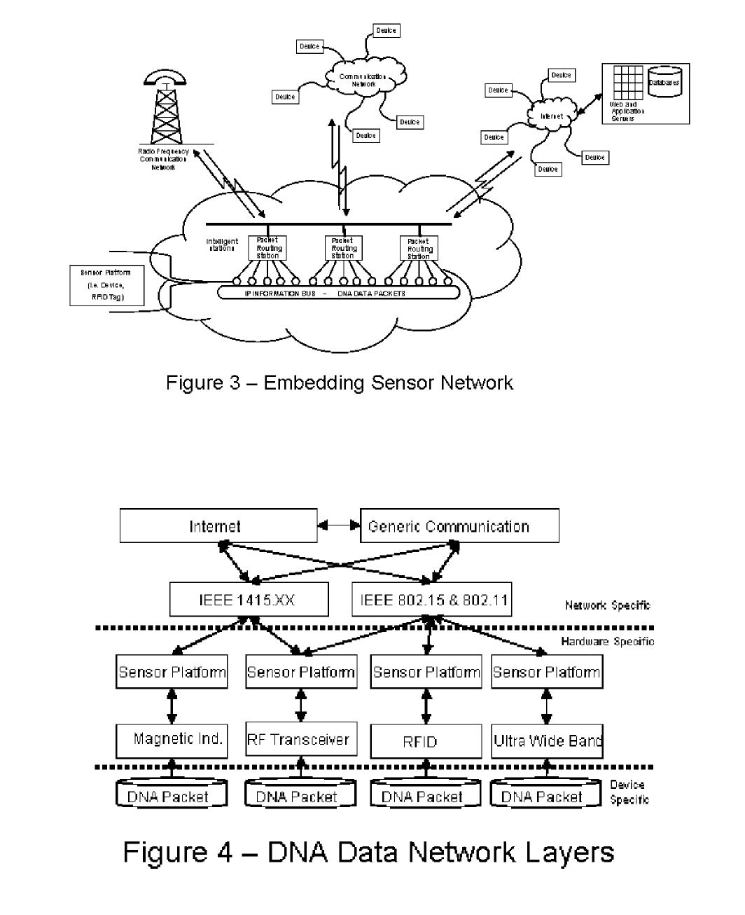

The Embedding System element consists of the Sensor Platform, Networking and Wireless Link. As discussed above, the sensor platform is the integrated Nano/Micro Electrical Mechanical System sensor chip. The Networking element is shown in FIG. 3 comprises of the sensor platform linked to routing stations using an IP based transport system. The routing stations are connected to the Internet, communication network, and RF wireless network. Using the Wireless Link, the sensor platform is able to broadcast the DNA data packet across the IEEE 802.15, IEEE 1415, and IEEE 802.11 wireless standards. Key components shown in FIG. 3 are the applications and databases that subscribe to the DNA data packets via identification service applications or information bus.

FIG. 4 shows the three DNA data network layers that are network specific, hardware specific and device specific. The lowest level is the device specific layer that consists of the broadcast of the DNA profile data packet. The next layer shows hardware specific sensor platform that includes the broadcast method and contains the DNA profile. The last layer is the network specific layer that uses standards to route the DNA packets across the network layers to the applications that subscribe to the packets. Routes are established “on demand” as requested by the source of which only the active routes are maintained by each node.

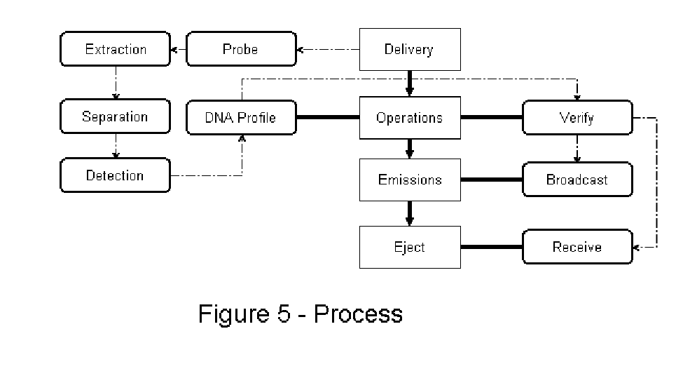

The final element is the Process element which consists of the following components: Delivery, Operations, and Emission. FIG. 5 shows the link between the three elements with the third element, emission, divided into the broadcast operations and the eject process. The Delivery component represents the attachment of the device to the subject. The steps to the right of the Delivery box represent the device specific steps to obtain the DNA profile. The preferred method of obtaining the DNA profile is using a device with a self-contained total analysis system for detection of the STR and/or SNP DNA sequences. The process starts with the probe component of the device adhering to the subject and extracting a sample for Separation and Detection of the DNA profile. The Operations process begins after the integrated Extraction and affixation process is completed and Separation of the sample for Detection begins. Once the DNA profile is obtained, the DNA profile is written to the sensor platform and the verification process begins.

The Verify step consists of the data packet consisting of the Device ID, the DNA profile, and time stamp being sent to the network to be remotely verified via the identification system's applications and databases. Once the system verifies the packet, a signal is sent to the device to start continuous broadcasting of the DNA data packet. The Eject process occurs when a Receive signal to release the device is received either during the verification process or during normal operations or if the device stops working. The eject process also refers to the optional step after verification of the DNA data packet occurs and the delivery functions of the device illustrated on the left side of the dotted line in FIG. 2 are no longer needed. Any portion of the mechanical structure of the probe used in the affixation process will remain.

### BACKGROUND OF INVENTION

Numerous systems have been conventionally implemented for determining a geographic location and other parameters associated with persons, things, or apparatuses. The various known location tracking devices, however, have a number of limitations that limit their usefulness in tracking populations. Such conventional systems typically include Global Positioning Systems (GPS) to perform the geo-location determination.

Additionally, numerous identity systems and devices been conventionally implemented for determining and verifying the identity of persons and animals. While passports, cards, licenses, certificates, biometrics, have been implemented in various manners, all have drawbacks associated with scalability and uniqueness and traditionally have not been direct linked to geographical location tracking.

Requirements for an ideal system include real time communications, a unique biometric identifier, and scalability that enables cost effectiveness and upgrades based on new technologies. Furthermore, conventional systems typically restrict users to monitor geo-location devices at dedicated monitoring systems that are tied to a GPS transmitter. Advancements in global communication networks, databases, biosensors, and RF MEMS have allowed the convergence of the combination of real time biosensors and real time tracking to create a scalable, cost effective, DNA based tracking and identification system.

Therefore, there exists a need for a system and method for real time tracking and identity verification via a scalable network. There further exists a need for a system and method to make use of existing communications infrastructure and future enhancements that will allow for integration into existing and future tracking systems. A ubiquitous method and system to combat identity theft and identity fraud while allowing for location tracking is needed.

1. An apparatus for establishing a global and universal location tracking and identity verification system based on a unique biometric identifier, DNA, comprising of:
a device that broadcasts DNA profile packets which uniquely identify a subject human or animal: and
b. an embedding sensor network that utilizes existing and planned communication networks to route DNA profile packets via Internet Protocols allowing determination of location.
c. a universal tracking and identification device.

2. The apparatus of claim 1, wherein the device that broadcasts the DNA profile packets comprises a transceiver that broadcasts data packets comprising a Device ID, a DNA profile, and a stamp.

3. The apparatus in claim 1, wherein the embedding sensor network uses one of IEEE 802.15, IEEE 1415, IEEE 802.11, radio frequency communications, magnetic induction communication, high frequency communications Internet protocol based data packet routine system, Internet protocol edge routers, intelligent stations linking communication networks, and applications and databases used for verification, location determination, and information retrieval.

4. A method allowing universal tracking and identification via DNA profile packets via a sensor platform and a sensor network to ensure identify and determine identification, the method comprising the steps of:
a. delivery of the sensor platform to a subject via implantation, adhesion, or digestion;
b. obtaining a DNA Profile of the subject;
c. verifying the DNA profile of the subject; and
d. broadcasting the DNA profile of the subject, a Device ID, and a time stamp.

5. The apparatus of claim 2 wherein the transceiver that broadcasts data packets communicates the DNA profile of the subject to a external network.

6. The apparatus of claim 1 wherein the device that broadcasts DNA profile packets comprises a sensor platform built on an integrated Nano or Micro electrical mechanical system containing an radio frequency transceiver.

7. The method of claim 4 wherein the step of obtaining the DNA profile is self contained and uses a Micro total analysis system (μ-TAS) or a lab-on-a-chip.

8. The apparatus of claim 6 wherein the sensor platform comprises a device for powering internal operations by a power source selected from the group consisting of a rechargeable battery, transmissions, vibrations, and chemical reactions.

9. The method of claim 4, further comprising the step of determining location using one of GPS, assisted GPS, gyro, accelerometer, high frequency sound, magnetic induction, and combinations thereof.

10. The method of claim 4, further comprising the step of releasing components not associated with the step of broadcasting the DNA profile of the subject after the step of verifying the DNA profile of the subject.

11. The apparatus of claim 1, wherein the DNA profile packets comprises one of STR, DNA sequences. SNP, DNA sequences, or combinations thereof.
